(19) United States
(12) Patent Application Publication
(10) Pub. No.: US 2006/0044159 A1
(43) Pub. Date: Mar. 2, 2006

(54) Warning unit

(75) Inventor: Paul Andrew Wilson, Hockley (GB)

Correspondence Address: Edwin D. Schindler;Five Hirsch Avenue, P. O. Box 966, Coram, NY, 11727-0966, US

(73) Assignee: Medico Industries Inc., Wilkes-Barre, PA (US)

(21) Appl. No.: 11/208,563

(22) Filed: Aug. 22, 2005

Related U.S. Application Data
(63) Continuation of application No. 10/480,718, filed on Dec. 11, 2003, now abandoned.

(30) Foreign Application Priority Data
Jun. 11, 2001 (GB) 0114179.5
Dec. 6, 2001 (GB) 0129178.0

(51) Int. Cl. G08G 1/095; G08B 21/00; G08B 23/00

(52) U.S. Cl. 340/908; 340/687; 340/693.5; 340/693.9

(57) ABSTRACT

A warning unit includes an upright housing in which a sound emitter is disposed, along with a sensor for responding to the approach of a pedestrian to energize the sound emitter. A suction device is provided in the bottom of the warning unit for engaging the floor to retain the unit in position, the suction device having an actuating lever disposed within the housing and accessible through a normally-locked door of the housing.

### CROSS-REFERENCE TO RELATED APPLICATIONS

This is a continuation of application Ser. No. 10/480,718, filed Dec. 11, 2003, now abandoned, which represents the U.S. National Phase application of P.C.T. Application No. PCT/GB02/02539, filed Jun. 5, 2002.

### BACKGROUND OF THE INVENTION

1. Technical Field of the Invention

The present invention relates to a warning unit and more particularly to a warning unit for use in providing a warning of an e.g. wet floor in a public building or other walkway.

2. Description of the Prior Art

It is common to place a warning device on the floor of a public building, such as a shopping centre, or of a public walkway, to warn pedestrians of an area of floor which is wet, for example, because it has been washed, or otherwise temporarily unsuitable for walking over.

I have now devised a warning unit which provides a warning of improved effectiveness to pedestrians.

### SUMMARY OF THE INVENTION

In accordance with the present invention, there is provided a warning unit which comprises a structure for standing upright on the floor and including a housing in which sound emitting means are mounted, a sensor for responding to the approach of a pedestrian to energise the sound emitting means, and a suction device provided in the bottom of the unit and operable for engaging the floor to retain the unit in position, the suction device having an actuating lever disposed within said housing and accessible through a door of said housing.

Preferably the housing of the warning unit is elongate in form, the bottom of the housing standing on the floor, either directly 6r via a base of the unit. An upper portion of the housing may taper towards the top of the unit. The housing may be square or circular in cross-section, or of any other appropriate cross-sectional shape.

Preferably the sensor is positioned at or adjacent the top of the unit. Preferably the sound emitting means is positioned adjacent the top of the unit. Preferably the side wall or walls of the housing are formed with openings (e.g. grilles) to allow the emission of the sounds generated by the sound emitting means.

Preferably the warning unit is arranged to replay a verbal message via the sound emitting means. Preferably a facility is provided to select the verbal message which will be replayed, from a number of available messages. Preferably the unit is arranged to permit new messages to be recorded.

The warning unit may be provided with a flashing light which is energised in response to the sensor sensing the approach of a pedestrian.

### BRIEF DESCRIPTION OF THE DRAWING FIGURES

An embodiment of the present invention will now be described by way of example only and with reference to the accompanying drawings, in which:

FIG. 1 is an isometric view of a warning unit in accordance with the present invention; and

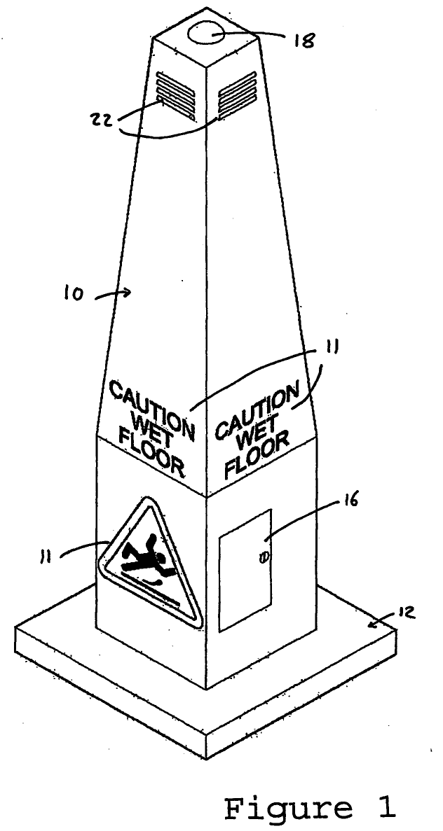

FIG. 2 is a vertical section through the warning unit shown in FIG. 1.

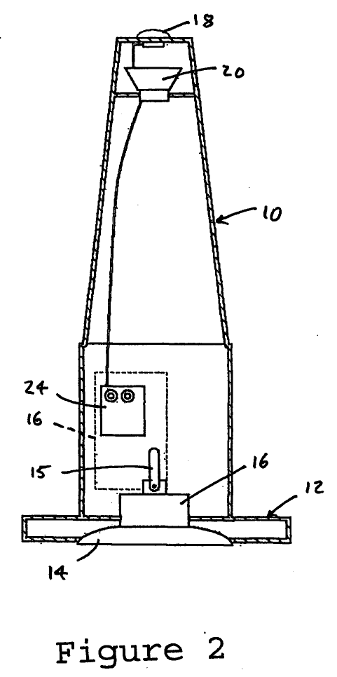

### DETAILED DESCRIPTION OF THE DRAWING FIGURES AND PREFERRED EMBODIMENTS

Referring to the drawings, there is shown a warning unit which comprises an upright, hollow housing 10 provided with a generally flat base 12, for standing upright on the floor. The housing 10 is of generally square cross-section and an upper portion tapers towards the top. The base 12 is square in shape, somewhat larger than the housing 10, and is formed integrally with the housing 10. The housing 10 and base 12 may each be of alternative shapes in plan view, e.g. circular.

A suction device is mounted in the base of the unit, and comprises a suction cup 14 for engaging the floor, the suction cup 14 being carried by a mount 16 from the top of which an actuating lever 15 projects. The lever 15 is coupled to the centre of the suction cup 14 and arranged so that, upon turning the lever, the centre of the suction cup 14 is raised in order to create a vacuum between the cup and the floor, for securing the unit to the floor: when the lever is turned in the opposite direction, the centre of the suction cup lowers in order to break the vacuum and release the unit from the floor. Access to the manually-operable lever 15 is obtained through a normally-locked door 16 in one side wall of the housing 10.

A proximity sensor 18 is mounted to the flat top of the housing 10 and a loudspeaker 20 is mounted within the housing 10 adjacent its top: the side walls of the housing 10 are formed with grilles 22 adjacent the loudspeaker 20, to allow the emission of sounds generated by the loudspeaker. A control unit 24 is mounted within the housing 10 and is accessible through the door 16.

In use the warning unit is placed in an appropriate position on the floor and secured in place by actuating the suction device via the lever 15. The unit is then switched on using an ON/OFF switch on the control unit 24, accessible through the door 16.

Should a pedestrian approach the area of floor or walkway protected by the warning unit, the proximity sensor 18 senses the pedestrian and causes the control unit 24 to play a recorded audible message, which is relayed by the loudspeaker 20. The warning unit may include a flashing light, at or adjacent its top, which is energised at the same time. The control unit 24 may be arranged to play any of a number of different messages, selected by a selector switch on the control unit 24.

It will be noted that the outside surfaces of the housing 10 carry visual warning signs and messages 11.

Although not shown in the drawings, preferably one or more tapes or other elongate flexible elements are provided, for linking between the warning unit and other structure (e.g. similar units), to form a barrier to pedestrians. In particular, the warning unit may include one or more retractable tape units from which the tapes may be extended when required.

Preferably the unit includes a movement sensor arranged to provide an audible alarm in the event that the unit is moved by an unauthorised person. The movement sensor may comprise one or more tilt switches, or a pressure switch acting between the underside of the unit and the floor. The audible alarm is preferably relayed through the loudspeaker 20.

What is claimed is:

1-9. (canceled)

10. A warning unit, comprising:
a structure for standing upright on a floor;
a housing having a door included with said structure;
means for emitting sound mounted within said housing;
a sensor for responding to an approach of a pedestrian for energizing said means for emitting sound; and,
a suction device in a bottom part of said warning unit and operable for engaing the floor for retaining said warning unit in position, said suction device having an actuating lever disposed within said housing and accessible through said door of said housing for operating said suction device.

11. The warning unit according to claim 10, wherein said housing has an elongate shape.

12. The warning unit according to claim 11, wherein an upper portion of said housing tapers towards a top part of said warning unit.

13. The warning unit according to claim 10, wherein said sensor is positioned at a top part of said warning unit.

14. The warning unit according to claim 10, wherein said sensor is positioned adjacent to a top part of said warning unit.

15. The warning unit according to claim 10, wherein said means for emitting sound includes means for replaying a verbal message.

16-19. (canceled)
